(19) United States
(12) Patent Application Publication
(10) Pub. No.: US 2023/0120508 A1
(43) Pub. Date: Apr. 20, 2023

(54) BATTERY AND ELECTRIC APPARATUS HAVING SUCH BATTERY

(71) Applicant: Ningde Amperex Technology Limited, Ningde City (CN)

(72) Inventors: Guowen Zhang, Ningde City (CN); Wu Ma, Ningde City (CN)

(73) Assignee: Ningde Amperex Technology Limited, Ningde City (CN)

(21) Appl. No.: 18/080,857

(22) Filed: Dec. 14, 2022

Related U.S. Application Data
(63) Continuation of application No. PCT/CN2020/096217, filed on Jun. 15, 2020.

(51) Int. Cl. H01M 50/593; H01M 50/586; H01M 50/531; H01M 50/169; H01M 50/171; H01M 50/184; H01M 50/186

(52) U.S. Cl. CPC H01M 50/593; H01M 50/586; H01M 50/531; H01M 50/169; H01M 50/171; H01M 50/184; H01M 50/186; H01M 2220/30

(57) ABSTRACT

A battery includes a housing and a battery cell accommodated in the housing. The battery further includes an insulator accommodated in the housing, where the insulator is located between the housing and the battery cell and is provided with a through hole having a size greater than 100 μm and less than or equal to 2000 μm.

### CROSS REFERENCE TO THE RELATED APPLICATIONS

This application is a continuation under 35 U.S.C. § 120 of international patent application PCT/CN2020/096217 filed on Jun. 15, 2020, the entire contents of which are incorporated herein by reference.

### TECHNICAL FIELD

This application relates to a battery and an electric apparatus having such battery.

### BACKGROUND

As is well known, a battery typically includes a housing and a battery cell located in the housing. In some cases, the housing needs to be electrically connected to a tab of the battery cell so that the housing has a same polarity as the tab. However, when the battery falls or vibrates, the battery cell is apt to directly contact the housing, causing short circuit which leads to security risks.

Moreover, the housing is typically provided with an injection opening through which electrolyte is injected into the housing. However, due to relatively slow permeation of the electrolyte during electrolyte injection, infiltration of the electrolyte into electrode plates of the battery cell is impacted.

### SUMMARY

In view of this, it is necessary to provide a battery able to avoid short circuit of battery cells and guarantee full infiltration into electrode plates during electrolyte injection.

In addition, it is also necessary to provide an electric apparatus having such battery.

This application provides a battery including a housing and a battery cell accommodated in the housing. The battery further includes an insulator accommodated in the housing, where the insulator is located between the housing and the battery cell and is provided with a through hole having a hole diameter greater than 100 μm and less than or equal to 2000 μm.

In some embodiments of this application, the battery cell is a laminated cell including a first end portion, a second end portion opposite the first end portion, and a side surface connected between the first end portion and the second end portion. The battery cell is provided with a first tab and a second tab, where the first tab and the second tab extend from the side surface, and the insulator is located between the side surface and the housing.

In some embodiments of this application, the first tab and the second tab are located between the side surface and the insulator.

In some embodiments of this application, at least one of the first tab or the second tab is located between the insulator and the housing.

In some embodiments of this application, at least one of the first tab or the second tab is provided with an insulation glue.

In some embodiments of this application, the insulator is annular.

In some embodiments of this application, the battery cell is a laminated cell including a first end portion, a second end portion opposite the first end portion, and a side surface connected between the first end portion and the second end portion. The battery cell is provided with a first tab and a second tab, where the first tab and the second tab extend from the side surface, and the insulator is located between the first end portion and the housing or between the second end portion and the housing.

In some embodiments of this application, the insulator includes at least one of polypropylene, polyethylene terephthalate, polystyrene, polyimide, nylon, or polytetrafluoroethylene.

In some embodiments of this application, shape of the through hole is at least one of circle, oval, square, triangle, or polygon.

In some embodiments of this application, the through hole is circular and has a hole diameter greater than 100 μm and less than or equal to 2000 μm.

In some embodiments of this application, the battery cell is a winding cell.

In some embodiments of this application, the housing includes a first housing body and a second housing body covering the first housing body, the first housing body being welded to the second housing body. The battery further includes a pole, where the pole is arranged on the second housing body and is insulated from the second housing body. The battery cell is provided with a first tab and a second tab, where the first tab is electrically connected to the pole, and the second tab is electrically connected to any one of the first housing body or the second housing body.

In some embodiments of this application, the housing includes a first housing body and a second housing body covering the first housing body, the first housing body being connected to the second housing body through a seal ring. The battery cell is provided with a first tab and a second tab, where the first tab is electrically connected to the first housing body, and the second tab is electrically connected to the second housing body.

In some embodiments of this application, porosity of the insulator is 10%-50%.

In some embodiments of this application, a ratio of the hole diameter of the through hole to thickness of the battery is 3 mm:40 mm-3 mm:100 mm.

This application further provides an electric apparatus, where the electric apparatus includes the foregoing battery.

According to this application, the insulator is arranged between the housing and the battery cell to prevent the battery cell from directly contacting the housing, thus avoiding short circuit and improving safety performance and service life of the battery. In addition, the insulator is provided with the through hole, so when injected into the housing, the electrolyte can pass through the through hole and fully infiltrate the battery cell, improving permeation of the electrolyte into electrode plates of the battery cell and guaranteeing good contact interfaces between the electrode plate and the electrolyte.

### BRIEF DESCRIPTION OF DRAWINGS

FIG. 1 is a top view of a battery according to an embodiment of this application.

FIG. 2 is a side view of the battery shown in FIG. 1.

FIG. 3 is a cross-sectional view of the battery shown in FIG. 1 along A-A.

FIG. 4 is a cross-sectional view of the battery shown in FIG. 1 along A-A according to another embodiment.

FIG. 5 is a cross-sectional view of the battery shown in FIG. 1 along A-A according to still another embodiment.

FIG. 6 is a schematic structural diagram of an insulator of the battery shown in FIG. 5.

FIG. 7 is a cross-sectional view of a battery according to another embodiment of this application.

FIG. 8 is a schematic structural diagram of an electric apparatus according to an embodiment of this application.

### REFERENCE SIGNS OF MAIN COMPONENTS

Electric apparatus 1
Housing 10
First housing body 11
Second housing body 12
Pole 13
Injection plug 14
Seal ring 15
Battery cell 20
First end portion 20a
Second end portion 20b
Side surface 20c
First electrode plate 21
Second electrode plate 22
Insulator 30
Through hole 31
Battery 100, 200, 300, and 400
Accommodation space 110
First tab 210
First adapting piece 211
Second tab 220
Second adapting piece 221
Insulation glue 230

This application will be further described with reference to the accompanying drawings in the following specific embodiments.

### DETAILED DESCRIPTION

The following clearly and completely describes the technical solutions in the embodiments of this application with reference to the accompanying drawings in the embodiments of this application. Apparently, the described embodiments are only some but not all of the embodiments of this application. All other embodiments obtained by a person of ordinary skill in the art based on the embodiments of this application without creative efforts shall fall within the protection scope of this application.

Unless otherwise defined, all technical and scientific terms used herein shall have the same meanings as commonly understood by those skilled in the art to which this application belongs. The terms used herein in the specification of this application are merely intended to describe specific embodiments but not to limit this application.

The following describes in detail some embodiments of this application with reference to the accompanying drawings. In absence of conflicts, the following embodiments and features in the embodiments may be combined.

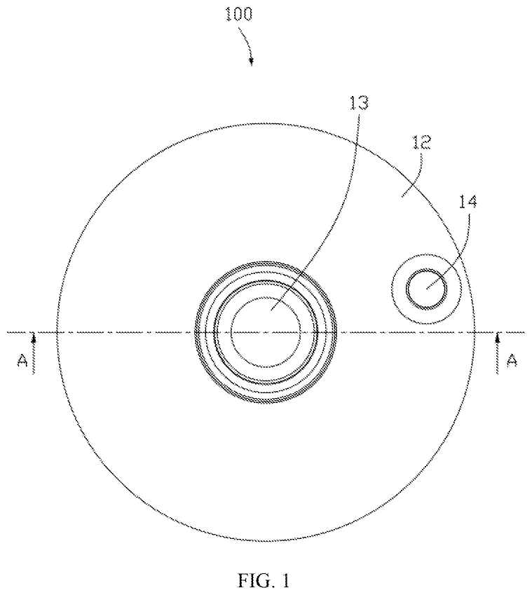

Referring to FIG. 1 to FIG. 3, an embodiment of this application provides a battery 100 including a housing 10 and a battery cell 20 accommodated in the housing 10. The battery 100 further includes an insulator 30 accommodated in the housing 10, where the insulator 30 is located between the housing 10 and the battery 20. The insulator 30 is provided with a through hole 31 having a hole diameter greater than 100 μm and less than or equal to 2000 μm.

According to this application, the insulator 30 is arranged between the housing 10 and the battery cell 20 to prevent the battery cell 20 from directly contacting the housing 10, thus avoiding short circuit and improving the safety performance and the service life of the battery 100. Furthermore, in this application, the insulator 30 may be provided with a plurality of through holes 31. Therefore, when injected into the housing 10, the electrolyte can pass through the through holes 31 and fully infiltrate the battery cell 20, improving permeation of the electrolyte into electrode plates of the battery cell 20 and guaranteeing good contact interfaces between the electrode plates and the electrolyte.

In some embodiments of this application, porosity of the insulator 30 is 10%-50%.

In some embodiments of this application, a ratio of the hole diameter of the through hole 31 to thickness of the battery 100 is 3 mm:40 mm-3 mm:100 mm.

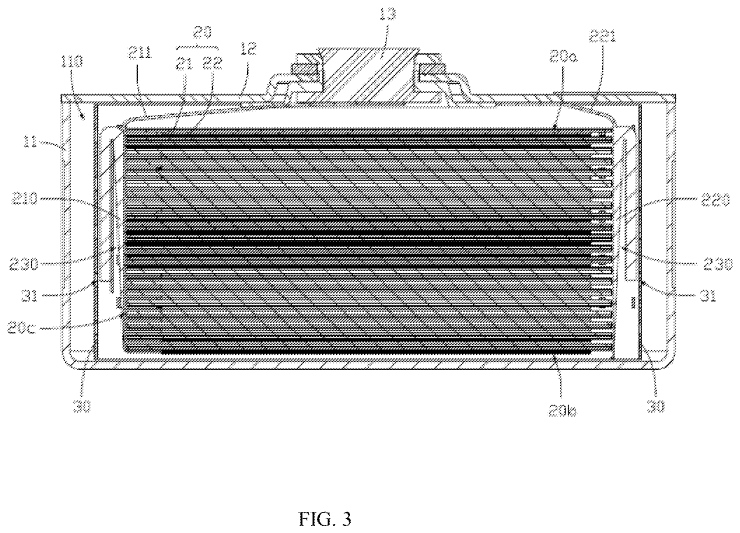

As shown in FIG. 3, in this embodiment, the battery cell 20 is a laminated cell. The laminated cell includes a first end portion 20a, a second end portion 20b arranged opposite the first end portion 20a, and a side surface 20c connected between the first end portion 20a and the second end portion 20b. The battery cell 20 is provided with a first tab 210 and a second tab 220. The first tab 210 and the second tab 220 extend from the side surface 20c, and the insulator 30 is located between the side surface 20c and the housing 10.

Specifically, the battery cell 20 includes a first electrode plate 21, a second electrode plate 22, and a separator (not shown in the figure) located between the first electrode plate 21 and the second electrode plate 22, where the first electrode plate 21, the separator, and the second electrode plate 22 form the battery cell 20 by stacking. The first electrode plate 21 includes a first current collector and a first active material layer arranged on a surface of the first current collector, and the first tab 210 may be electrically connected to the first current collector by welding. The second electrode plate 22 includes a second current collector and a second active material layer arranged on a surface of the second current collector, and the second tab 220 may be electrically connected to the second current collector by welding.

Moreover, the housing 10 includes a first housing body 11 and a second housing body 12 covering the first housing body 11, the first housing body 11 being welded to the second housing body 12. The battery 100 further includes a pole 13, where the pole 13 is arranged on the first housing body 11 and is insulated from the first housing body 11. The first tab 210 is electrically connected to the pole 13, and the second tab 220 is electrically connected to any one of the first housing body 11 or the second housing body 12.

The first tab 210 being electrically connected to the pole 13 enables the pole 13 to present a same polarity as the first electrode plate 21. For example, when the first electrode plate 21 is a negative electrode plate, the pole 13 may present a negative polarity. The second tab 220 being electrically connected to the first housing body 11 or the second housing body 12 enables the housing 10 to overall present a same polarity as the second electrode plate 22. For example, when the first electrode plate 22 is a positive electrode plate, the housing 10 may overall present a positive polarity. Moreover, the insulator 30 being arranged between the side surface 20c and the housing 10 enables the insulator 30 to prevent the housing 10 from directly contacting the first electrode plate 21, thereby avoiding short circuit.

In this embodiment of this application, the insulator 30 is annular. Therefore, the insulator 30 may be arranged around the side surface 20c of the battery cell 20 to provide a better insulation effect.

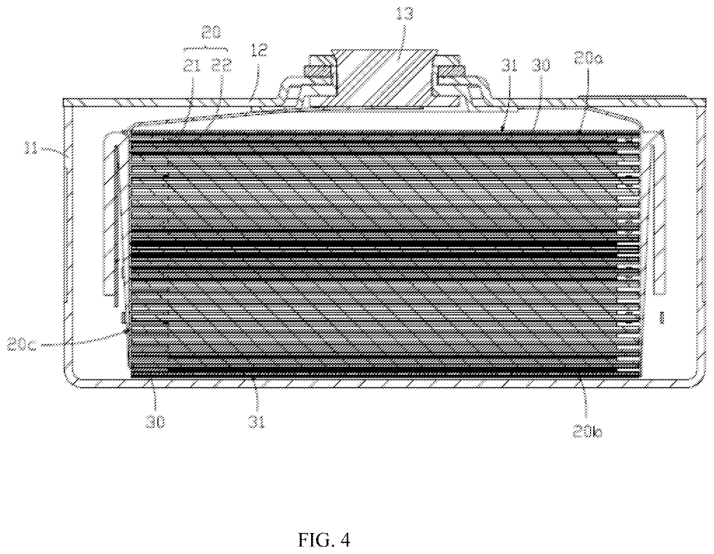

Referring to FIG. 4, in another embodiment, the insulator 30 is located between the first end portion 20a and the housing 10 or between the second end portion 20b and the housing 10. Therefore, the insulator 30 can prevent the end portion of the battery cell 20 from directly contacting the housing 10, thereby avoiding short circuit. In addition, the insulator 30 is further configured to prevent the pole 13 from piercing the electrode plates of the battery cell 20 during an extrusion test, thereby avoiding short circuit.

As shown in FIG. 4, the first insulator 30 is provided in a quantity of two. One of the insulators 30 is located between the first end portion 20a and the second housing body 12 and is configured to prevent the battery cell 20 from directly contacting the pole 13. The other insulator 30 is located between the second end portion 20b and the first housing body 11 and is configured to prevent the battery cell 20 from directly contacting a bottom wall of the first housing body 11.

In this case, shape of the insulator 30 may be circle, oval, square, triangle, polygon, or the like.

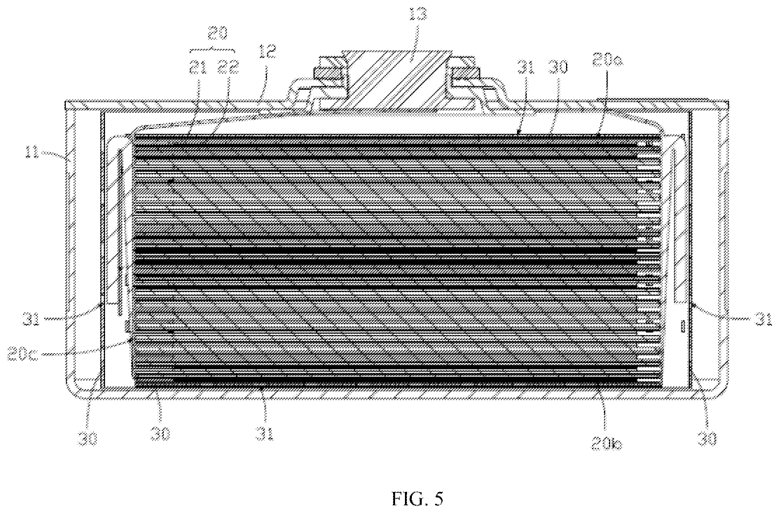

Referring to FIG. 5, in still another embodiment, besides being located between the side surface 20c and the housing 10, the insulator 30 is also located between the first end portion 20a and the housing 10 and between the second end portion 20b and the housing 10. Therefore, the insulator 30 surrounds an entire surface of the battery cell 20 to allow the electrolyte to fully infiltrate the battery cell 20 from all the directions through the through holes 31 of the insulator 30, so that the electrolyte has the highest possible permeation into the electrode plates of the battery cell 20.

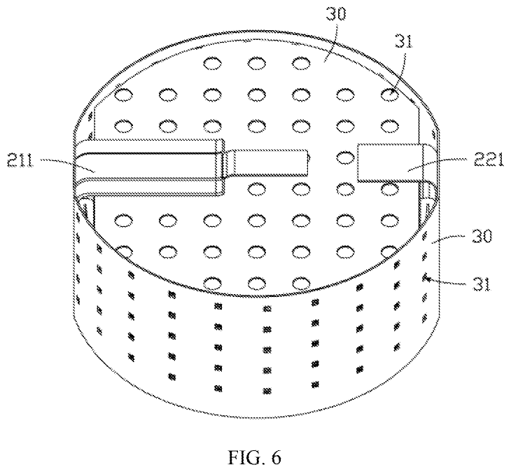

Also referring to FIG. 6, a schematic structural diagram of the insulator 30, in this case, the insulator 30 can surround the entire surface of the battery cell 20. The first tab 210 is connected to the pole 13 through a first adapting piece 211, and the second tab 220 is connected to the second housing body 12 through a second adapting piece 221. The first adapting piece 211 and the second adapting piece 221 are both located between the insulator 30 and the second housing body 12 to prevent the first adapting piece 211 and the second adapting piece 221 from directly contacting the battery cell 20.

As shown in FIG. 3, in this embodiment, the first tab 210 and the second tab 220 are located between the side surface 20c and the insulator 30. Therefore, the insulator 30 further can prevent the housing 10 from directly contacting the first tab 210 or second tab 220 that has an opposite polarity (in this embodiment, the one having the opposite polarity is the first tab 210), thereby avoiding short circuit.

Moreover, at least one of the first tab 210 or the second tab 220 is provided with insulation glue 230, where the insulation glue 230 can be configured to prevent the first tab 210 from directly contacting the second electrode plate 22 or prevent the second tab 220 from directly contacting the first electrode plate 21, thereby avoiding short circuit. In addition, the insulation glue 230 can further provide a buffering force for the first tab 210 or the second tab 220 to restrict bending stress produced by the first tab 210 or the second tab 220 due to being bent.

In another embodiment, at least one of the first tab 210 or the second tab 220 may be further located between the insulator 30 and the housing 10. In this case, at least one of the first tab 210 or the second tab 220 can be also provided with the insulation glue 230, where the insulation glue 230 can be configured to prevent the housing 10 from directly contacting the first tab 210 or second tab 220 that has an oppose polarity (in this embodiment, the one having the opposite polarity is the first tab 210), thereby avoiding short circuit.

In this embodiment, the insulator 30 includes at least one of polypropylene (PP), polyethylene terephthalate (PET), polystyrene (PS), polyimide (PI), nylon, or polytetrafluoroethylene (PTFE). The first insulator 30 may be in a single-layer structure, or may be in a multi-layer composite structure.

In this embodiment of this application, shape of the through hole 31 is at least one of circle, oval, square, triangle, or polygon. The through hole 31 may be formed by stamping, laser cutting or other processes. The through hole 31 is circular and has a diameter greater than 100 μm and less than or equal to 2000 μm.

As shown in FIG. 3, the first housing body 11 is provided with an accommodation space 110 for accommodating the battery cell 20, and the second housing body 12 is mounted on the first housing body 11 to seal the accommodation space 110. In other words, the second housing body 12 is a top cover of the housing 10. The first housing body 1I and the second housing body 12 may be made of metal. For example, the first housing body 11 and the second housing body 12 may be made of steel alloy, aluminum alloy, iron alloy, copper alloy, nickel alloy, or the like.

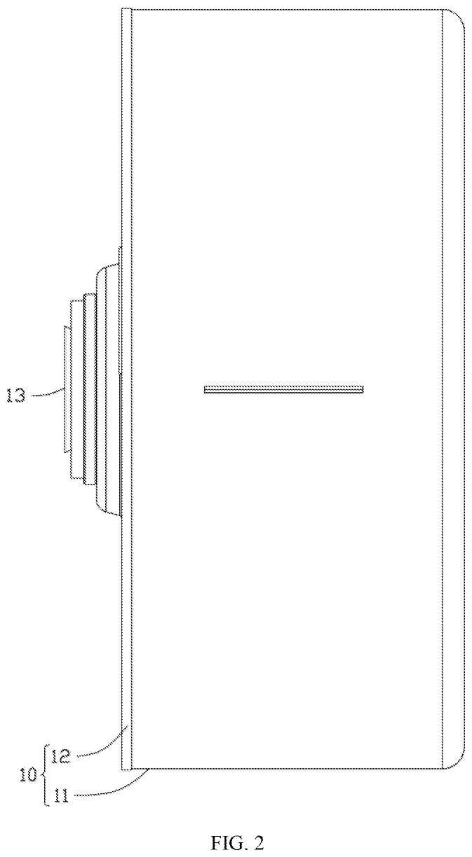

As shown in FIG. 1 and FIG. 2, the battery 100 in this embodiment is a button cell, and the first housing body 11 and the second housing body 12 are both made of stainless steel. During preparation, the first housing body 11 and the second housing body 12 may be made into required shapes by laser cutting, machine tool processing, or other processes. The first housing body 11 may alternatively be provided with a scour hole (which is the accommodation space 110) by stamping.

As shown in FIG. 1, in this embodiment, the second housing body 12 is provided with an injection hole (not shown in the figure) through which the electrolyte can be injected. An injection plug 14 is arranged inside the injection hole, where the injection plug 14 is configured to seal the injection hole and prevent the injected electrolyte from leaking or prevent external foreign matter from entering the battery. Certainly, the injection hole may further be located in the first housing body 11.

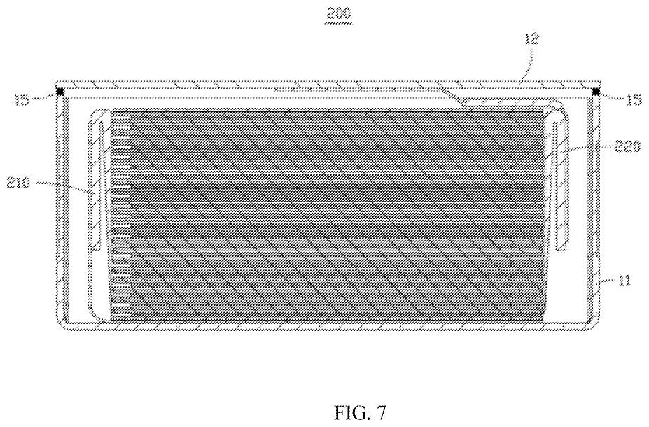

As shown in FIG. 7, another embodiment of this application further provides a battery 200 which is different from the above battery 100 in that the battery 200 may have no pole 13. Specifically, the housing 10 includes a first housing body 11 and a second housing body 12 covering the first housing body 11. The first housing body 11 is connected to the second housing body 12 through a seal ring 15. The first tab 210 is electrically connected to the first housing body 11, and the second tab 220 is electrically connected to the second housing body 12.

Therefore, polarities of the first electrode plate 21 and the second electrode plate 22 can be led out to the second housing body 12 and the first housing body 11, respectively. Furthermore, removing the pole reduces overall thickness of the housing 10, which can improve energy density of the battery 200 under the same overall volume of the battery 200.

Still another embodiment of this application further provides a battery (not shown in the figure). The difference from the above battery 100 is that a battery cell of the battery is a winding cell.

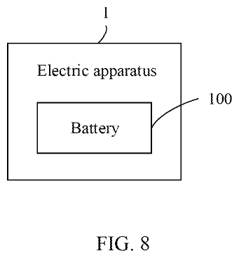

Referring to FIG. 8, this application further provides an electric apparatus 1, where the electric apparatus 1 includes the foregoing battery 100 (or the battery 200, 300, or 400). The electric apparatus 1 may be a consumer electronic product, for example, a smartphone. It can be understood that in other embodiments, the electric apparatus 1 may alternatively be an electric tool, an energy storage apparatus, a motive apparatus, or the like. For example, the electric apparatus 1 may alternatively be an electric vehicle.

The foregoing descriptions are merely preferable embodiments of this application, which are not intended to limit this application. Any modifications, equivalent replacements, and improvements made without departing from the spirit and principle of this application shall fall within the protection scope of this application.

What is claimed is:

1. A battery, comprising a housing and a battery cell accommodated in the housing; wherein,
the battery further comprises an insulator accommodated in the housing, wherein the insulator is located between the housing and the battery cell and is provided with a through hole having a hole diameter greater than 100 μm and less than or equal to 2000 μm.

2. The battery according to claim 1, wherein the battery cell is a laminated cell comprising a first end portion, a second end portion opposite to the first end portion, and a side surface connected between the first end portion and the second portion; and
the battery cell is provided with a first tab and a second tab, wherein the first tab and the second tab extend from the side surface, and the insulator is located between the side surface and the housing.

3. The battery according to claim 2, wherein the first tab and the second tab are located between the side surface and the insulator.

4. The battery according to claim 2, wherein at least one of the first tab or the second tab is located between the insulator and the housing.

5. The battery according to claim 2, wherein at least one of the first tab or the second tab is provided with an insulation glue.

6. The battery according to claim 2, wherein the insulator is annular.

7. The battery according to claim 1, wherein the battery cell is a laminated cell comprising a first end portion, a second end portion opposite to the first end portion, and a side surface connected between the first end portion and the second portion; and
the battery cell is provided with a first tab and a second tab, wherein the first tab and the second tab extend from the side surface, and the insulator is located between the first end portion and the housing or between the second end portion and the housing.

8. The battery according to claim 1, wherein the insulator comprises at least one of polypropylene, polyethylene terephthalate, polystyrene, polyimide, nylon, or polytetrafluoroethylene.

9. The battery according to claim 1, wherein a shape of the through hole is at least one of circle, oval, square, triangle, or polygon.

10. The battery according to claim 1, wherein the through hole is circular and has a hole diameter greater than 100 am and less than or equal to 2000 μm.

11. The battery according to claim 1, wherein the battery cell is a winding cell.

12. The battery according to claim 1, wherein the housing comprises a first housing body and a second housing body covering the first housing body, the first housing body being welded to the second housing body;
the body further comprises a pole, wherein the pole is arranged on the second housing body and is insulated from the second housing body; and
the battery cell is provided with a first tab and a second tab, wherein the first tab is electrically connected to the pole, and the second tab is electrically connected to any one of the first housing body or the second housing body.

13. The battery according to claim 1, wherein the housing comprises a first housing body and a second housing body covering the first housing body, the first housing body being connected to the second housing body through a seal ring; and
the battery cell is provided with a first tab and a second tab, wherein the first tab is electrically connected to the first housing body, and the second tab is electrically connected to the second housing body.

14. The battery according to claim 1, wherein a porosity of the insulator is 10%-50%.

15. The battery cell according to claim 1, wherein a ratio of the hole diameter of the through hole to a thickness of the battery is 3 mm:40 mm-3 mm-100 mm.

16. An electric apparatus, comprising the battery according to claim 1.

17. The electric apparatus according to claim 16, wherein the battery cell is a laminated cell comprising a first end portion, a second end portion opposite to the first end portion, and a side surface connected between the first end portion and the second portion; and
the battery cell is provided with a first tab and a second tab, wherein the first tab and the second tab extend from the side surface, and the insulator is located between the first end portion and the housing or between the second end portion and the housing or between the side surface and the housing.

18. The electric apparatus according to claim 16, wherein a porosity of the insulator is 10%-50%.

19. The electric apparatus according to claim 16, wherein a ratio of the hole diameter of the through hole to a thickness of the battery is 3 mm:40 mm-3 mm:100 mm.

20. The electric apparatus according to claim 17, wherein at least one of the first tab or the second tab is provided with an insulation glue.
